(19) United States
(12) Patent Application Publication
(10) Pub. No.: US 2026/0281743 A1
(43) Pub. Date: Sep. 17, 2026

(54) INCREASING TOTAL READER PROCESSING TIME LIMITS FOR TRANSMISSIONS

(71) Applicant: QUALCOMM Incorporated, San Diego, CA (US)

(72) Inventors: Sheng-Yuan TU, San Diego, CA (US); Venkatraman RAJAGOPALAN, San Diego, CA (US); Scott HOOVER, Del Mar, CA (US); Brian GEORGE, San Diego, CA (US)

(21) Appl. No.: 19/081,683

(22) Filed: Mar. 17, 2025

(51) Int. Cl. H04W 24/02; H04W 56/00

(52) U.S. Cl. CPC H04W 24/02; H04W 56/001

(57) ABSTRACT

In some aspects, a user equipment (UE) may receive, via a reader associated with the UE and from a tag, a first transmission. The UE may transmit, via the reader and to the tag, a second transmission based at least in part on the first transmission, wherein the first transmission and the second transmission are separated by a turnaround time, and wherein one or more parameters, including the turnaround time, are selected to increase a total reader processing time limit associated with one or more of the first transmission or the second transmission. Numerous other aspects are described.

### FIELD OF THE DISCLOSURE

Aspects of the present disclosure generally relate to wireless communication and specifically relate to techniques, apparatuses, and methods associated with increasing total reader processing time limits for transmissions.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

In some implementations, an apparatus for wireless communication at a user equipment (UE) includes one or more memories; and one or more processors, coupled to the one or more memories, configured to cause the UE to: receive, via a reader associated with the UE and from a tag, a first transmission; and transmit, via the reader and to the tag, a second transmission based at least in part on the first transmission, wherein the first transmission and the second transmission are separated by a turnaround time, and wherein one or more parameters, including the turnaround time, are selected to increase a total reader processing time limit associated with one or more of the first transmission or the second transmission.

In some implementations, a method of wireless communication performed by a UE includes receiving, via a reader associated with the UE and from a tag, a first transmission; and transmitting, via the reader and to the tag, a second transmission based at least in part on the first transmission, wherein the first transmission and the second transmission are separated by a turnaround time, and wherein one or more parameters, including the turnaround time, are selected to increase a total reader processing time limit associated with one or more of the first transmission or the second transmission.

In some implementations, a non-transitory computer-readable medium storing a set of instructions for wireless communication includes one or more instructions that, when executed by one or more processors of a UE, cause the UE to: receive, via a reader associated with the UE and from a tag, a first transmission; and transmit, via the reader and to the tag, a second transmission based at least in part on the first transmission, wherein the first transmission and the second transmission are separated by a turnaround time, and wherein one or more parameters, including the turnaround time, are selected to increase a total reader processing time limit associated with one or more of the first transmission or the second transmission.

In some implementations, an apparatus for wireless communication includes means for receiving, via a reader associated with the apparatus and from a tag, a first transmission; and means for transmitting, via the reader and to the tag, a second transmission based at least in part on the first transmission, wherein the first transmission and the second transmission are separated by a turnaround time, and wherein one or more parameters, including the turnaround time, are selected to increase a total reader processing time limit associated with one or more of the first transmission or the second transmission.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless network, in accordance with the present disclosure.

FIG. 2 is a diagram illustrating an example disaggregated network node architecture, in accordance with the present disclosure.

FIG. 3 is a diagram illustrating an example of a remote tag reader system, in accordance with the present disclosure.

FIG. 4 is a diagram illustrating an example of tag-reader communications, in accordance with the present disclosure.

FIG. 5 is a diagram illustrating an example associated with increasing total reader processing time limits for transmissions, in accordance with the present disclosure.

FIG. 6 is a flowchart illustrating an example process performed, for example, by a user equipment (UE), in accordance with the present disclosure.

FIG. 7 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In a remote tag reader transmission (e.g., a radio frequency identification (RFID) transmission), a UE, via a reader (interrogator), may transmit a continuous wave signal (CW) signal. The reader may transmit one or more commands via the CW signal. A command may be transmitted via a broadcast, or the command may be a dedicated command. For example, the reader may transmit, via a broadcast, a select command and a query command, which may be received by a tag. The tag may transmit a 16-bit random number (RN16) response based at least in part on the query command. The reader may transmit, via a dedicated command, an acknowledgement (ACK) command, which may be received by the tag. The tag may transmit an electronic product code (EPC) response based at least in part on the ACK command. The reader may transmit a query rep command or a negative acknowledgement (NACK) command, which may be received by the tag. An amount of time between the query command and the RN16 response may be defined by a time, T1. An amount of time between the RN16 response and the ACK command may be defined by a time, T2. An amount of time between the ACK command and the EPC response may be defined by T1. An amount of time between the EPC response and the query rep command or the NACK command may be defined by T2.

The reader may select a backscatter link frequency (BLF) according to tag read rate requirements for a given use case, while meeting any other regulatory constraints. Actual values of a maximum T2 limit may be defined for applicable BLFs. For a downlink BLF of 160 kilohertz (KHz), a maximum T2 may be 125 microseconds (μs), and a buffering delay may be approximately 50 μs, thereby resulting in a total reader processing time limit of approximately 75 μs. For a downlink BLF of 200 KHz, a maximum T2 may be 100 μs, and a buffering delay may be approximately 50 μs, thereby resulting in a total reader processing time limit of approximately 50 μs. For a downlink BLF of 250 KHz, a maximum T2 may be 80 μs, and a buffering delay may be approximately 50 μs, thereby resulting in a total reader processing time limit of approximately 30 μs. For a downlink BLF of 300 KHz, a maximum T2 may be approximately 66.67 μs, and a buffering delay may be approximately 50 μs, thereby resulting in a total reader processing time limit of approximately 16.67 μs. For a downlink BLF of 600 KHz, a maximum T2 may be approximately 33.33 μs, and a buffering delay may be approximately 50 μs, thereby resulting in a total reader processing time limit of approximately −16.67 μs. In these examples, a front end delay and a buffering delay (or packetization delay) may be approximately 50 μs, which may result in a relatively tight total reader processing time limit, especially for relatively high downlink BLFs (e.g., 200 KHz and higher). The relatively tight total reader processing time limit may be difficult for the reader to satisfy, and in some cases, the reader may be unable to meet the total reader processing time limit, thereby degrading an overall system performance.

Various aspects relate generally to remote tag reader transmissions, such as RFID transmissions. Some aspects more specifically relate to total reader processing time limits for remote tag reader transmissions. In some examples, a reader (e.g., a reader associated with a UE) may receive, from a tag, a first transmission. The first transmission may be a downlink transmission. The reader may transmit, to the tag, a second transmission based at least in part on the first transmission. The second transmission may be an uplink transmission. The first transmission and the second transmission may be separated by a turnaround time. The reader may select one or more parameters, including the turnaround time, to increase a total reader processing time limit associated with one or more of the first transmission or the second transmission. The one or more parameters may be selected to increase a processing limit of the reader to process the first transmission, and/or the one or more parameters may be selected to increase a processing time limit of the reader to generate the second transmission.

In some aspects, the UE may select the turnaround time, of the one or more parameters, from a range of available turnaround times. The UE may select a data encoding type, of the one or more parameters, from a plurality of available data encoding types. For example, the data encoding type may be based at least in part on FM0 or Miller code. The UE may select a modulation type, of the one or more parameters, from a plurality of available modulation types. For example, the modulation type may be based at least in part on Miller code. The UE may select a BLF, of the one or more parameters, from a range of available BLFs. The total reader processing time limit for the second transmission may be based at least in part on the turnaround time, the data encoding type, the modulation type, and/or the BLF. In some aspects, the UE may select a type A reference interval (Tari), of the one or more parameters, from a range of available Taris. The UE may select a data multiple, of the one or more parameters, from a group of possible data multiples. The UE may identify a frame synchronization duration based at least in part on the Tari and the data multiple, where the total reader processing time limit for the second transmission may be increased based at least in part on the frame synchronization duration and the turnaround time. In some aspects, the UE may generate one or more frame synchronization samples or a preamble for the second transmission prior to a receipt of the first transmission. The reader may transmit the second transmission to the tag based at least in part on the one or more frame synchronization samples or the preamble. The total reader processing time limit may be increased based at least in part on a transmitted duration of the one or more frame synchronization samples or the preamble. In some aspects, the reader may generate one or more header bits and/or one or more data bits for the second transmission prior to the receipt of the first transmission. The reader may transmit the second transmission to the tag based at least in part on the one or more header bits and/or the one or more data bits. The total reader processing time limit may be increased based at least in part on the one or more header bits and/or the one or more data bits.

Particular aspects of the subject matter described in this disclosure can be implemented to realize one or more of the following potential advantages. In some examples, by selecting the one or more parameters and/or by generating the one or more frame synchronization samples, the one or more header bits, and/or the one or more data bits, the described techniques can be used by the reader to increase the total reader processing time limit for the second transmission. The reader may obtain an increased amount of time for processing in between the first transmission and the second transmission. The increased amount of time for processing may accommodate buffering delays associated with the reader (e.g., delays associated with receiving the first transmission and then transmitting the second transmission). By increasing the total reader processing time limit for the second transmission, the reader may be able to accommodate larger downlink BLFs (e.g., 300 KHz or 600 KHz) and smaller maximum T2 values (e.g., 66.67 μs or 33.33 μs), while still accounting for the buffering delays associated with the reader. As a result, an overall UE performance may be improved.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

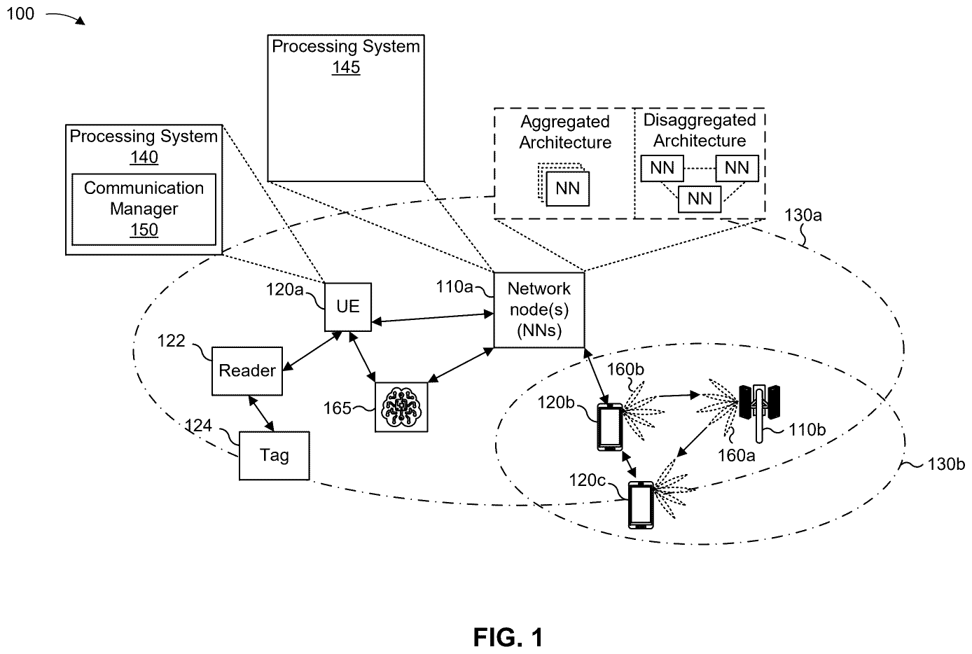

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

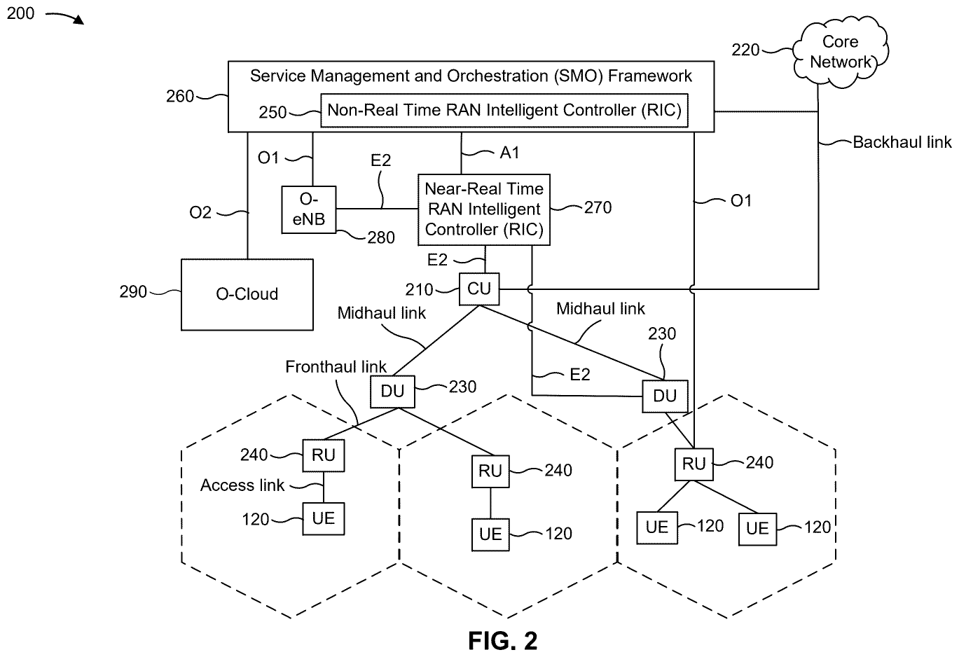

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ ACK indication or a HARQ NACK indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples.

In some aspects, a UE (e.g., the UE 120) may include a communication manager 150. As described in more detail elsewhere herein, the communication manager 150 may receive, via a reader associated with the UE and from a tag, a first transmission; and transmit, via the reader and to the tag, a second transmission based at least in part on the first transmission, wherein the first transmission and the second transmission are separated by a turnaround time, and wherein one or more parameters, including the turnaround time, are selected to increase a total reader processing time limit associated with one or more of the first transmission or the second transmission. Additionally, or alternatively, the communication manager 150 may perform one or more other operations described herein.

As indicated above, FIG. 1 is provided as an example. Other examples may differ from what is described with regard to FIG. 1.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

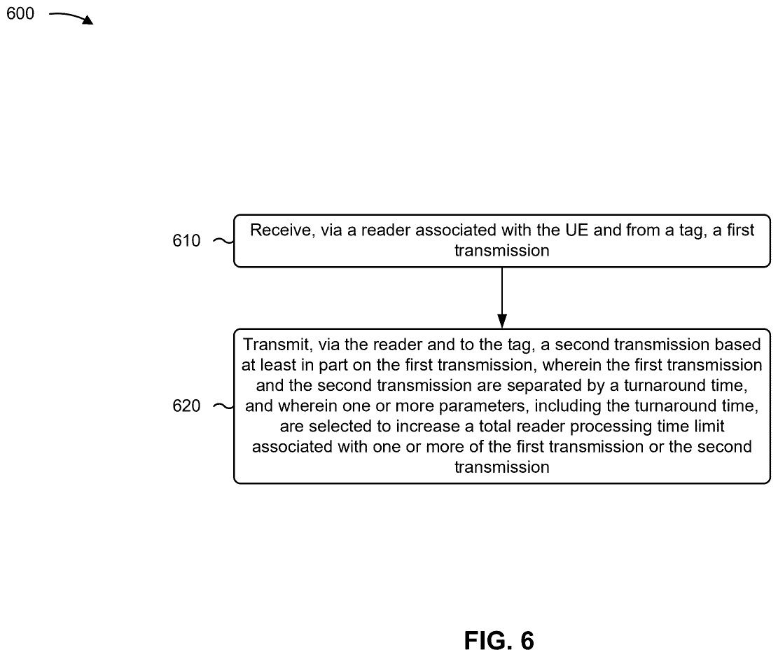

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with increasing total reader processing time limits for transmissions, as described in more detail elsewhere herein. For example, the processing system 145 of the network node 110, the processing system 140 of the UE 120, the CU 210, the DU 230, or the RU 240 may perform or direct operations of, for example, process 600 of FIG. 6, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 600 of FIG. 6, or other processes as described herein. In some examples, executing instructions may include running the instructions, converting the instructions, compiling the instructions, and/or interpreting the instructions, among other examples.

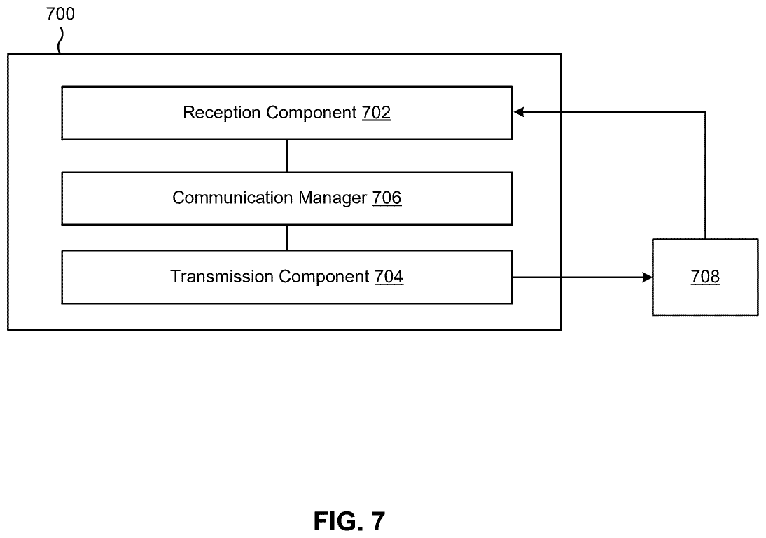

In some aspects, a UE (e.g., the UE 120) includes means for receiving, via a reader associated with the UE and from a tag, a first transmission; and/or means for transmitting, via the reader and to the tag, a second transmission based at least in part on the first transmission, wherein the first transmission and the second transmission are separated by a turnaround time, and wherein one or more parameters, including the turnaround time, are selected to increase a total reader processing time limit associated with one or more of the first transmission or the second transmission. The means for the UE to perform operations described herein may include, for example, one or more of communication manager 150, processing system 140, a radio, one or more RF chains, one or more transceivers, one or more antennas, one or more modems, a reception component (for example, reception component 702 depicted and described in connection with FIG. 7), and/or a transmission component (for example, transmission component 704 depicted and described in connection with FIG. 7), among other examples.

As indicated above, FIG. 2 is provided as an example. Other examples may differ from what is described with regard to FIG. 2.

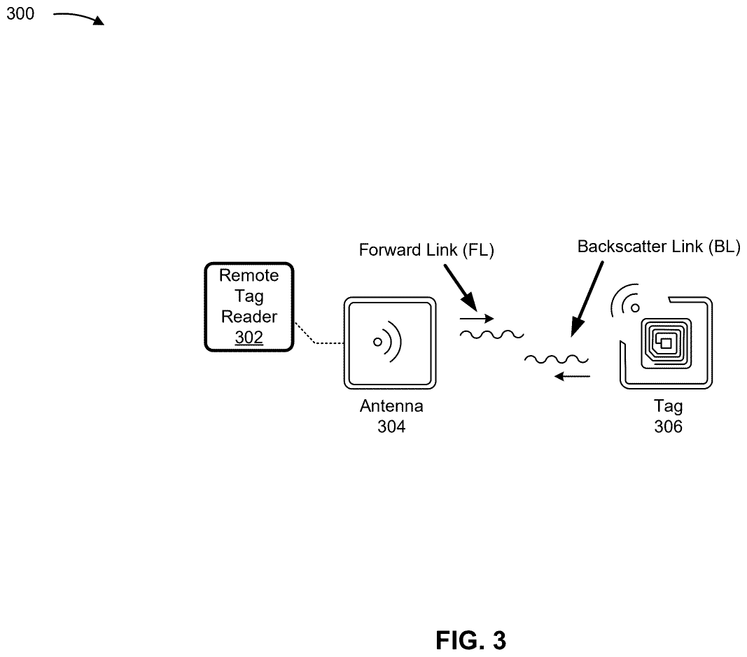

FIG. 3 is a diagram illustrating an example 300 of a remote tag reader system, in accordance with the present disclosure.

As shown in FIG. 3, in a remote tag reader system (e.g., an ultra-high frequency (UHF) RFID system), a remote tag reader 302 (e.g., an RFID reader or an interrogator) (corresponds to reader 122, as shown in FIG. 1) may be coupled to an antenna 304, and the remote tag reader 302 may communicate with a tag 306 (e.g., an RFID passive tag) (corresponds to tag 124, as shown in FIG. 1), which may be a passive device. The tag 306 may include a dipole antenna and an integrated circuit (IC). The antenna 304 coupled to the remote tag reader 302 may include a transmit antenna and a receive antenna. The remote tag reader 302 may transmit a CW signal to the tag 306 via a forward link, which may power up the tag 306 and allow the tag 306 to respond to the remote tag reader 302. The remote tag reader 302 may transmit a command to the tag 306 via the CW signal. The tag 306 may transmit a response to the remote tag reader 302 via a backscatter communication. The tag 306 may transmit the response via a backscatter link. The tag 306 may transmit the response without a battery or power source. The tag 306 may harvest (or absorb) power from the CW signal received from the remote tag reader 302, and the tag 306 may transmit the response using the harvested power. A reader-tag interaction may be based at least in part on a command-response model.

A UE may incorporate remote tag reader transmissions (e.g., RFID transmissions), which may allow the UE to act as the remote tag reader 302 that is able to communicate with the tag 306. The UE may run the remote tag reader concurrently with other RATs, such as NR, Long Term Evolution (LTE), Global System for Mobile Communications (GSM), wireless local area network (WLAN), and/or global navigation satellite system (GNSS), which may allow a user to operate the UE while initiating remote tag reader transactions (e.g., RFID transactions, or another RFID related use case). The UE may operate in a valid band (e.g., a valid RFID band) in a geographic region in which the valid band has been allowed and allocated to some spectrum. In one specific example, the UE may operate an RFID band in a 860-960 megahertz (MHz) band. The tag 306 may communicate back to the remote tag reader 302 via backscattering. The tag 306 may have a relatively high timing error. The remote tag reader 302 may use a half-duplex protocol to query the tag 306 and obtain a response from the tag 306.

A tag-to-reader transmission may be a downlink transmission, and a reader-to-tag transmission may be an uplink transmission. An uplink-to-downlink turnaround time may be defined by a T1 limit. The uplink-to-downlink turnaround time may be an amount of time between the uplink transmission and the downlink transmission. A downlink-to-uplink turnaround time may be defined by a T2 limit. The downlink-to-uplink turnaround time may be an amount of time between the downlink transmission and the uplink transmission. The uplink-to-downlink turnaround time and the downlink-to-uplink turnaround time may be relatively tight. For example, typical values for T1 and T2 may be between 50 μs and 100 μs. An uplink processing and a downlink processing may involve using substantial compute resources and at least one antenna for remote tag reader communications.

As indicated above, FIG. 3 is provided as an example. Other examples may differ from what is described with regard to FIG. 3.

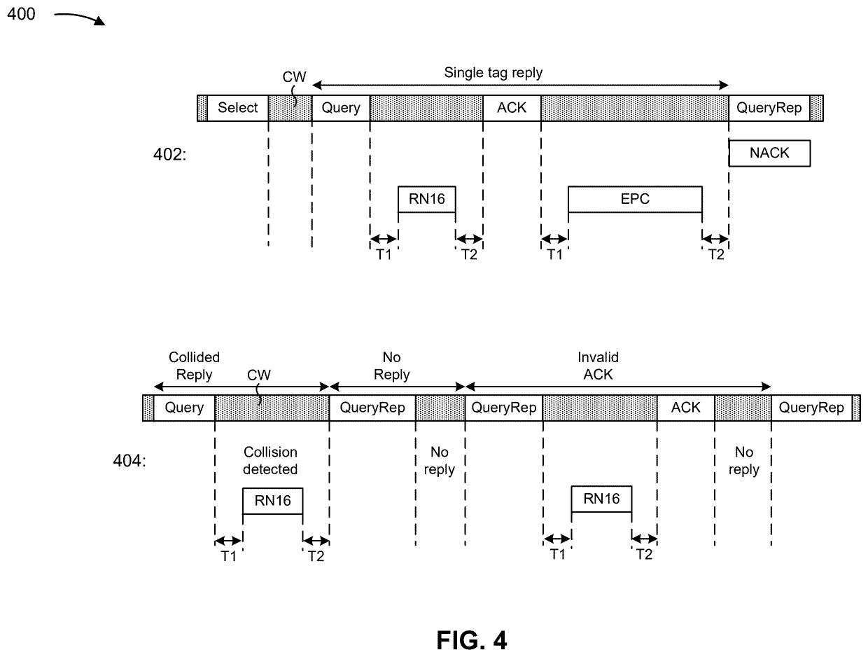

FIG. 4 is a diagram illustrating an example 400 of tag-reader communications, in accordance with the present disclosure.

As shown by reference number 402, a reader (interrogator) may transmit a CW signal. The reader may transmit one or more commands via the CW signal. A command may be transmitted via a broadcast, or the command may be a dedicated command. For example, the reader may transmit, via a broadcast, a select command and a query command, which may be received by a tag. The tag may transmit an RN16 response based at least in part on the query command. The reader may transmit, via a dedicated command, an ACK command, which may be received by the tag. The tag may transmit an EPC response based at least in part on the ACK command. The reader may transmit a query rep command or a NACK command, which may be received by the tag. An amount of time between the query command and the RN16 response may be defined by T1. An amount of time between the RN16 response and the ACK command may be defined by T2. An amount of time between the ACK command and the EPC response may be defined by T1. An amount of time between the EPC response and the query rep command or the NACK command may be defined by T2.

As shown by reference number 404, a reader (interrogator) may transmit a CW signal. The reader may transmit (e.g., broadcast) a query command, which may be received by a tag. The tag may transmit an RN16 response based at least in part on the query command, but due to a collision, the RN16 response may not be received by the reader (collided reply). The reader may transmit a query rep command. The reader may not receive any reply, so the reader may transmit a second query rep command. The second query rep command may be received by the tag. The tag may transmit an RN16 response to the reader based at least in part on the second query rep command.

The reader may transmit an ACK command, which may be received by the tag. The reader may not receive any reply (e.g., no EPC response may be received), so the reader may transmit a third query rep command. In other words, the reader may transmit the third query rep command due to an invalid ACK command.

As indicated above, FIG. 4 is provided as an example. Other examples may differ from what is described with regard to FIG. 4.

In a remote tag reader system (e.g., an RFID system), types of interactions between a reader and a tag may include an immediate reply and other kinds of reply. A T2 timeline may be a critical timeline that is to be satisfied by the reader for immediate reply messages. The T2 timeline may signify a downlink-to-uplink turnaround time that is to be satisfied by the reader. The downlink-to-uplink turnaround time may be a direct function of Tpri, where Tpri is an inverse of a BLF. In one example, link timing parameters may include T1 and T2. T1 may be associated with a minimum value, a nominal value, and a maximum value. T1 may indicate an immediate reply time from a reader (interrogator) transmission to a tag reply. The immediate reply time may be a time from a last rising edge of a last bit of the reader transmission to a first rising edge of the tag reply, measured at the tag's antenna terminals. The minimum value, the nominal value, and the maximum value may be based at least in part on Tpri. T2 may be associated with a minimum value and a maximum value. T2 may indicate a reader (interrogator) reply time when the tag is to demodulate a reader (interrogator) signal, measured from an end of a last (dummy) bit of a tag reply to a first falling edge of a reader (interrogator) transmission. The minimum value and the maximum value may be based at least in part on Tpri.

The reader may select the BLF (also referred to as a downlink chip rate) according to tag read rate requirements for a given use case, while meeting any other regulatory constraints. BLF selection use cases may involve selected tag read rate requirements, dense reader mode industry consensus, and/or European Telecommunications Standards Institute (ETSI) regulatory requirements. Actual values of a maximum T2 limit may be defined for applicable BLFs. For a downlink BLF of 160 KHz, a maximum T2 may be 125 μs, and a buffering delay may be approximately 50 μs, thereby resulting in a total reader processing time limit of approximately 75 μs. For a downlink BLF of 200 KHz, a maximum T2 may be 100 μs, and a buffering delay may be approximately 50 μs, thereby resulting in a total reader processing time limit of approximately 50 μs. For a downlink BLF of 250 KHz, a maximum T2 may be 80 μs, and a buffering delay may be approximately 50 μs, thereby resulting in a total reader processing time limit of approximately 30 μs. For a downlink BLF of 300 KHz, a maximum T2 may be approximately 66.67 μs, and a buffering delay may be approximately 50 μs, thereby resulting in a total reader processing time limit of approximately 16.67 μs. For a downlink BLF of 600 KHz, a maximum T2 may be approximately 33.33 μs, and a buffering delay may be approximately 50 μs, thereby resulting in a total reader processing time limit of approximately −16.67 μs. In these examples, a front end delay and a buffering delay (or packetization delay) may be approximately 50 μs, which may result in a relatively tight total reader processing time limit, especially for relatively high downlink BLFs (e.g., 200 KHz and higher). The relatively tight total reader processing time limit may be difficult for the reader to satisfy, and in some cases, the reader may be unable to meet the total reader processing time limit, thereby degrading an overall system performance.

In various aspects of techniques and apparatuses described herein, a reader (e.g., a reader associated with a UE) may receive, from a tag, a first transmission. The first transmission may be a downlink transmission. The reader may transmit, to the tag, a second transmission based at least in part on the first transmission. The second transmission may be an uplink transmission. The first transmission and the second transmission may be separated by a turnaround time. The reader may select one or more parameters, including the turnaround time, to increase a total reader processing time limit associated with one or more of the first transmission or the second transmission. The one or more parameters may be selected to increase a processing limit of the reader to process the first transmission, and/or the one or more parameters may be selected to increase a processing time limit of the reader to generate the second transmission.

In some aspects, the UE may select the turnaround time, of the one or more parameters, from a range of available turnaround times. The UE may select a data encoding type, of the one or more parameters, from a plurality of available data encoding types. The UE may select a modulation type, of the one or more parameters, from a plurality of available modulation types. The UE may select a BLF, of the one or more parameters, from a range of available BLFs. The total reader processing time limit for the second transmission may be based at least in part on the turnaround time, the data encoding type, the modulation type, and/or the BLF. In some aspects, the UE may select a Tari, of the one or more parameters, from a range of available Taris. The UE may select a data multiple, of the one or more parameters, from a group of possible data multiples. The UE may identify a frame synchronization duration based at least in part on the Tari and the data multiple, where the total reader processing time limit for the second transmission may be increased based at least in part on the frame synchronization duration and the turnaround time. In some aspects, the UE may generate one or more frame synchronization samples or a preamble for the second transmission prior to a receipt of the first transmission. The reader may transmit the second transmission to the tag based at least in part on the one or more frame synchronization samples or the preamble. The total reader processing time limit may be increased based at least in part on a transmitted duration of the one or more frame synchronization samples or the preamble. In some aspects, the reader may generate one or more header bits and/or one or more data bits for the second transmission prior to the receipt of the first transmission. The reader may transmit the second transmission to the tag based at least in part on the one or more header bits and/or the one or more data bits. The total reader processing time limit may be increased based at least in part on the one or more header bits and/or the one or more data bits.

In some aspects, by selecting the one or more parameters and/or by generating the one or more frame synchronization samples, the one or more header bits, and/or the one or more data bits, the reader may increase the total reader processing time limit for the second transmission. The reader may obtain an increased amount of time for processing in between the first transmission and the second transmission. The increased amount of time for processing may accommodate buffering delays associated with the reader (e.g., delays associated with receiving the first transmission and then transmitting the second transmission). By increasing the total reader processing time limit for the second transmission, the reader may be able to accommodate larger downlink BLFs (e.g., 300 KHz or 600 KHz) and smaller maximum T2 values (e.g., 66.67 μs or 33.33 μs), while still accounting for the buffering delays associated with the reader. As a result, an overall UE performance may be improved.

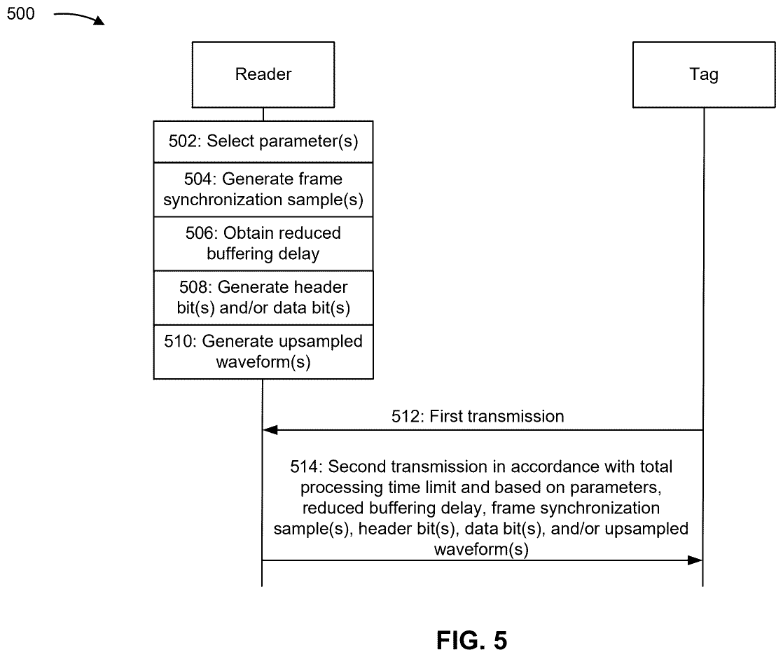

FIG. 5 is a diagram illustrating an example 500 associated with increasing total reader processing time limits for transmissions, in accordance with the present disclosure. As shown in FIG. 5, example 500 includes communication between a reader (e.g., reader 122) and a tag (e.g., tag 124). In some aspects, the reader and the tag may be included in a wireless network, such as wireless network 100. The reader may be associated with a UE (e.g., UE 120). The reader may be a remote tag reader, such as an RFID reader. The tag may be an RFID tag.

As shown by reference number 502, the reader may select one or more parameters to increase a total reader processing time limit. The total reader processing time limit may be for a second transmission (uplink transmission), which may be transmitted by the reader to the tag in response to a first transmission (downlink transmission) received by the reader from the tag. The reader may select a turnaround time (T2), of the one or more parameters, from a range of available turnaround times. The reader may select a BLF, of the one or more parameters, from a range of available BLFs. The reader may select a Tari, of the one or more parameters, from a range of available Taris. The reader may select a data multiple, of the one or more parameters, from a group of possible data multiples. The total reader processing time limit for the second transmission may be based at least in part on the turnaround time, the BLF, the Tari, and/or the data multiple. In some aspects, the UE may identify a frame synchronization duration based at least in part on the Tari and the data multiple, where the total reader processing time limit for the second transmission may be increased based at least in part on the frame synchronization duration and the turnaround time.

In some aspects, the reader may perform a T2 and BLF parameter selection, where T2 is a downlink-to-uplink turnaround time. The downlink-to-uplink turnaround time may be an amount of time between a downlink transmission and an uplink transmission. The downlink transmission may be a transmission from the tag to the reader. The uplink transmission may be a transmission from the reader to the tag. The reader may perform the T2 and BLF parameter selection, from an available range of downlink BLF values and corresponding T2 values, and the T2 and BLF parameter selection may be in consideration of various tag read performance tradeoffs.

In some aspects, for a downlink BLF of 160 KHz, a minimum T2 may be 18.75 μs, a maximum T2 may be 125 μs, and a buffering delay (or buffering latency) may be approximately 50 μs. For a downlink BLF of 200 KHz, a minimum T2 may be 15 μs, a maximum T2 may be 100 μs, and a buffering delay may be approximately 50 μs. For a downlink BLF of 250 KHz, a minimum T2 may be 12 μs, a maximum T2 may be 80 μs, and a buffering delay may be approximately 50 μs. For a downlink BLF of 300 KHz, a minimum T2 may be approximately 9.99 μs, a maximum T2 may be approximately 66.68 μs, and a buffering delay may be approximately 50 μs. For each downlink BLF, an allowed range (minimum and maximum values) for T2 may be defined, where the allowed range for T2 may correspond to an allowed range for a critical downlink-to-uplink turnaround time T2 parameter.

In some aspects, the T2 and BLF parameter selection may be based at least in part on a reader control. The reader may select T2 values that are relatively close to a maximum permissible value, even though selecting the maximum permissible value may be a tradeoff in terms of an overall tag read performance. The reader may select the T2 values that are relatively close to the maximum permissible value to ensure that a total processing time limit is satisfied by the reader. The reader may not select T2 values that are relatively close to a minimum permissible value, as selecting such T2 values may not cover a buffering delay. In other words, the buffering delay may be greater than a minimum T2 value, thus ensuring that the total processing time limit is not satisfied by the reader. In addition, for concurrency or non-concurrency modes in a normal operation, the reader may select a relatively low downlink BLF (e.g., 160 kHz or 200 KHz), which may increase an allowable latency, where the allowable latency is a function of the BLF.

As shown by reference number 504, the reader may generate one or more frame synchronization samples or a preamble for the second transmission prior to a receipt of the first transmission. The second transmission may be transmitted to the tag based at least in part on the one or more frame synchronization samples or the preamble. The total reader processing time limit for the second transmission may be increased based at least in part on a transmitted duration of the one or more frame synchronization samples or the preamble.

In some aspects, the reader may perform a pipelined downlink processing and an uplink frame synchronization pre-generation ahead of an actual turnaround window (T2), which may effectively increase a reader processing budget. In other words, the reader may perform the pipelined downlink processing and an uplink message prefix (frame synchronization) generation ahead of time. A remote tag reader transmission, such as an RFID transmission, and either the downlink transmission or the uplink transmission, may include a CW and a known pattern prefix. The known pattern prefix may be frame synchronization (FrameSync) samples. The known pattern prefix may be a fixed a priori known pattern for all uplink transmissions, and the known pattern prefix may not depend on downlink transmission. The reader may generate the known pattern prefix ahead of time for possible configurations of uplink parameters. The uplink parameters may involve a tuple that includes a Tari and a data multiple. The Tari may be a set time duration of a pulse of energy used to represent a “ ” bit in binary data transmitted by the tag. The reader may generate the known pattern prefix ahead of time, such that uplink processing related computations may not need to be performed during an actual turnaround window (T2). The uplink parameters may be fixed for each session, which may allow the reader to copy pre-generated frame synchronization samples into a transmit buffer ahead of time (e.g., prior to a downlink sample arrival from the tag) and/or transmit the pre-generated frame synchronization samples ahead of time. By obtaining and/or transmitting the pre-generated frame synchronization samples ahead of time, an overall reader processing time limit may be increased by a time duration. The time duration may depend on the pipelined downlink processing with uplink frame synchronization waveform generation.

In some aspects, the reader may perform a Tari and data multiple parameter selection. The reader may perform the Tari and data multiple parameter selection, from an available range of Tari values and corresponding data multiple values, and the Tari and data multiple parameter selection may be against various tag read performance tradeoffs. The overall reader processing time limit may be increased by a duration of the frame synchronization samples, and since a frame synchronization duration is a duration of tuple parameters (e.g., a Tari duration and a data multiple), the Tari and data multiple parameter selection may be optimized to obtain a longest length frame synchronization. The Tari and data multiple parameter selection may be in consideration of various tag read rate performance tradeoffs.

In some aspects, the frame synchronization duration may be defined in accordance with: 12.5 μs+Tari duration (in μs)×(Num_data_0+Num_data_1×data multiple), where Num_data_0=2 and Num_data_1=1. A range of allowable Tari lengths may be 6.25 μs to 25 μs. A range of allowable data multiples may be (1.5, 2). The reader may select a highest possible Tari length with a tradeoff against an overall tag read rate requirement, thereby resulting in an increased reader processing time limit.

In some aspects, for a downlink BLF of 160 KHz, a maximum T2 may be 125 μs, a Tari selection may be 20 μs or 25 μs, a selected data multiple may be 2, a frame synchronization may be 92.5 μs or 112.5 μs, and an updated reader processing time limit (T2 plus frame synchronization) may be 217.5 μs or 237.5 μs. For a downlink BLF of 200 KHz, a maximum T2 may be 100 μs, a Tari selection may be 20 μs, a selected data multiple may be 2, a frame synchronization may be 92.5 μs, and an updated reader processing time limit (T2 plus frame synchronization) may be 192.5 μs.

For a downlink BLF of 250 KHz, a maximum T2 may be 80 μs, a Tari selection may be 25 μs, a selected data multiple may be 2, a frame synchronization may be 112.5 μs, and an updated reader processing time limit (T2 plus frame synchronization) may be 202.5 μs. For a downlink BLF of 300 KHz, a maximum T2 may be approximately 66.67 μs, a Tari selection may be 12.5 μs or 21.5 μs, a selected data multiple may be 2, a frame synchronization may be 62.5 μs or 98.5 μs, and an updated reader processing time limit (T2 plus frame synchronization) may be 129.1 μs or 165.1 μs. For a downlink BLF of 600 KHz, a maximum T2 may be approximately 33.3 μs, a Tari selection may be 10.75 μs, a selected data multiple may be 2, a frame synchronization may be 112555 μs, and an updated reader processing time limit (T2 plus frame synchronization) may be 88.8 μs. In these examples, increasing a selected Tari may result in a longer frame synchronization, which may result in a longer reader processing time limit.

As shown by reference number 506, the reader may obtain a reduced buffering delay. The reduced buffering delay may be based at least in part on a shortened packet size, one or more blocks of received samples, an increased buffering rate, and/or a reduced buffer size. The reduced buffering delay may refer to a buffering delay that is reduced in relation to a buffering delay that uses a longer packet size, a decreased buffering rate, and/or an increased buffer size. For example, the reader may obtain a first buffering delay using a first packet size, a first buffering rate, and/or a first buffer size. The reader may obtain a second buffering delay using a second packet size, a second buffering rate, and/or a second buffer size, where the first buffering rate may be reduced in relation to the second buffering rate. The total reader processing time limit for the second transmission may be increased based at least in part on the reduced buffering delay and/or a reduced buffering latency.

In some aspects, the reader may attempt to reduce an overall buffering delay, which may allow the reader to increase the total processing time limit. For a given downlink BLF, a minimum T2 value, and a maximum T2 value, a reduced buffering delay may result in an increased total processing time limit. The reader may reduce the overall buffering latency based at least in part on a front end latency reduction. A front end latency may be based at least in part on a downlink latency and an uplink latency with respect to a reader antenna that performs the downlink transmission and the uplink transmission.

In some aspects, for downlink latency reduction, instead of a X sample packet, the reader may utilize a short packet mode to reduce a packetization delay, where X is a positive integer. The reader may also increase a downlink buffering rate, which may reduce the packetization delay. The increased downlink buffering rate may impact a downlink processing complexity, so the reader may select an optimal downlink buffering rate that is a tradeoff between performance and overall latency.

In some aspects, for uplink latency reduction, instead of a transmit path having a Y sample pre-fetch buffer, where Y is a positive integer, the reader may utilize a transmit path having a Z sample pre-fetch buffer, where Z is a positive integer that is less than Y. The reader may ensure that a transmit signal generation pipeline is operable with a reduced sample pre-fetch buffer. The reader may increase an uplink buffering rate, so that an impact of the Z sample pre-fetch buffer on an overall latency is reduced, while considering an overall computation requirement. In addition, a requirement on an upsampling chain may be reduced and an overall day of an uplink signal processing chain may be relatively low once a higher uplink buffering rate is selected.

As shown by reference number 508, the reader may generate one or more header bits and/or one or more data bits for the second transmission prior to the receipt of the first transmission. The second transmission may be transmitted to the tag based at least in part on the one or more header bits and/or the one or more data bits. The total reader processing time limit for the second transmission may be increased based at least in part on the one or more header bits and/or the one or more data bits.

In some aspects, the reader may pre-generate a known a priori uplink data header and a limited set of data bit combinations for critical timeline uplink transmissions. In time critical sequences involving a T2 maximum limit turnaround time, uplink transmissions may include an ACK command, a query rep command, a request random number (RN) command, a NACK command, and/or a query adjust command. Such uplink transmissions may include a known a priori uplink data header and some fixed known bits. The reader may pre-generate baseband waveforms of the known a priori uplink data header for the uplink transmissions, along with the frame synchronization, which may result in an increased reader processing time limit. For example, for an ACK command, such pre-generation of the baseband waveforms of the known a priori uplink data header may result in a direct margin increase of an RN16-to-T2-to-ACK turnaround time.

In some aspects, for other T2 scenarios (e.g., EPC-to-T2-to-uplink message), the reader may perform the pre-generation for all possible uplink responses (first four bits), but may copy samples of a specific uplink transmission header based at least in part on downlink transmission processing results. The other T2 scenarios may result in no net increase in T2, but may move an uplink computation of an uplink transmission header and data (first four bits) ahead of time, and due to such computation savings, additional time for downlink processing within a T2 plus frame synchronization duration may be achieved. For different uplink transmissions, a certain number of bits may be fixed, which may correspond to an increase in the overall reader processing time limit. The reader may arrive at the first four bits, for example, following an EPC response. In addition, the reader may pipeline uplink data sample generation for a number of bits greater than 4, with an uplink transmission of the first four bits.

When a reader-to-tag uplink transmission is a query command, a number of a priori known head bits may be 4 (e.g., 3 Data-0 bits and 1 Data-1 bit), a number of uplink data bits considered for pre-generation may be 0, a number of unique uplink data bit combinations that are pre-generated may be 0, and an uplink data sample update may not be linked to a downlink. When a tag-to-reader downlink transmission is an RN16 and a reader-to-tag uplink transmission is an ACK command, a number of a priori known head bits may be 2 (e.g., 1 Data-0 bits and 1 Data-1 bit), a number of uplink data bits considered for pre-generation may be 6, a number of unique uplink data bit combinations that are pre-generated may be 64, and an uplink data sample update may not be linked to a downlink.

When a tag-to-reader downlink transmission is an EPC and a reader-to-tag uplink transmission is a query rep command, a number of a priori known head bits may be 2 (e.g., 2 Data-0 bits and 0 Data-1 bits), a number of uplink data bits considered for pre-generation may be 2, a number of unique uplink data bit combinations that are pre-generated may be 1, and an uplink data sample update may be linked to a downlink. When a tag-to-reader downlink transmission is an EPC and a reader-to-tag uplink transmission is a query adjust command, a number of a priori known head bits may be 4 (e.g., 2 Data-0 bits and 2 Data-1 bits), a number of uplink data bits considered for pre-generation may be 0, a number of unique uplink data bit combinations that are pre-generated may be 0, and an uplink data sample update may be linked to a downlink.

When a tag-to-reader downlink transmission is an EPC and a reader-to-tag uplink transmission is a NACK command, a number of a priori known head bits may be 8 (e.g., 6 Data-0 bits and 2 Data-1 bits), a number of uplink data bits considered for pre-generation may be 0, a number of unique uplink data bit combinations that are pre-generated may be 0, and an uplink data sample update may be linked to a downlink.

When a tag-to-reader downlink transmission is an EPC and a reader-to-tag uplink transmission is a request RN command, a number of a priori known head bits may be 8 (e.g., 5 Data-0 bits and 3 Data-1 bits), a number of uplink data bits considered for pre-generation may be 0, a number of unique uplink data bit combinations that are pre-generated may be 0, and an uplink data sample update may be linked to a downlink.

In some aspects, the reader may receive, from the tag, a portion of bits associated with the first transmission (e.g., RN16). The reader may transmit, to the tag, the portion of bits (e.g., in an ACK command) prior to a receipt of remaining bits associated with the first transmission. The remaining bits may be subsequently received from the tag and transmitted by the reader to the tag.

In some aspects, the reader may pre-generate ACK data bit combinations and perform an early determination of RN16 uplink bits from a downlink, which may pipeline an uplink and downlink processing. In time critical sequences involving a T2 maximum limit turnaround time, RN16 may involve an ACK command. The ACK command may include a 2 bit header, which may be pre-generated, along with 16 data bits, which may be a copy (echo) of data bits received in the RN16. Due to a downlink processing, the reader may first decipher 6 bits of decoded data (in some cases 4 bits), after receiving and processing 10 bits of decoded downlink data.

In some aspects, the reader may pre-generate 2⁶=64 possible combinations of uplink waveforms at the uplink buffering rate, and the reader may store the pre-generated possible combinations of uplink waveforms. The reader may determine a copied (echoed) first 6 bits of uplink data, immediately after processing bits 1 to 10 of decoded downlink data, and before processing bits 11 to 16 of the decoded downlink data. After downlink bits 1 to 10 are processed, the reader may copy a particular bit combination waveform into a transmit memory following a frame synchronization and ACK header (already pre-generated) ahead of a downlink sample arrival (e.g., ahead of downlink bits 11 to 16). The reader may subsequently process and send the downlink bits 11 to 16. In other words, the reader may start sending the ACK command even before the RN16 is fully received and processed by the reader. The reader may pipeline downlink processing bits 11 to 16 with additional time to transmit samples for ACK bits, which may effectively reduce a requirement to only process to bit 10 until a T2 plus frame synchronization plus ACK header duration, and which may allow for an additional 6 bits of transmit waveform duration for processing downlink bits 11-16.

As an example, the reader may receive, from the tag, a preamble (e.g., 62.5 μs in duration). The reader may immediately receive, from the tag, RN16 (e.g., 100 μs in duration). A target T2 (e.g., a selected T2 value) may immediately begin after the RN16. For example, the target T2 may be 112.5 μs. The target T2 may be immediately followed by a frame synchronization. The frame synchronization may be immediately followed by an ACK header. The ACK header may be immediately followed by an ACK command. The ACK command may be divided into a first 6 bits, a second 6 bits, and a last 4 bits. The reader may begin sending the ACK command before all 16 bits of the RN16 are received and processed. In other words, the reader may begin to send the ACK command even when some downlink processing of the RN16 has not yet been completed. While the reader transmits the first 6 bits of the ACK command, the reader may complete the downlink processing.

As shown by reference number 510, the reader may generate one or more upsampled waveforms for the second transmission prior to the receipt of the first transmission. The one or more upsampled waveforms may be based at least in part on component waveforms associated with decomposed past second transmissions. The one or more upsampled waveforms may be based at least in part on a pre-generation of waveforms (e.g., data-0 and data-1 waveforms). The reader may decompose past second transmissions in order to derive a plurality of component waveforms. Prior to the receipt of the first transmission, the reader may pre-generate component waveforms, from the plurality of component waveforms, and then the reader may compose the second transmission by combining and/or concatenating the component waveforms. The second transmission may be transmitted to the tag based at least in part on the one or more upsampled waveforms. The total reader processing time limit for the second transmission may be increased based at least in part on the one or more upsampled waveforms.

In some aspects, the reader may reduce a processing complexity by pre-generating upsampled waveforms with a tradeoff against an adjacent channel leakage ratio (ACLR) for different waveforms. The reader may perform an uplink transmission upsampling generation. The reader may perform the upsampling in advance at a per bit level, which may allow waveforms to be concentrated based at least in part on an input data bit requirement. The pre-generated upsampled waveforms may result in a slight discontinuity as compared to an online generation of upsampled samples, but may help to reduce an overall uplink processing time (uplink real-time computation complexity) at the expense of a slight ACLR degradation.

As shown by reference number 512, the reader may receive, from the tag, the first transmission. The first transmission may be the downlink transmission. In some cases, the reader may receive the first transmission, and then the UE may select the one or more parameters, obtain the reduced buffering delay, generate the one or more frame synchronization samples, generate the one or more header bits and/or the one or more data bits, and/or generate the one or more upsampled waveforms.

As shown by reference number 514, the reader may transmit, to the tag, the second transmission based at least in part on the first transmission. The first transmission and the second transmission may be separated by the turnaround time. The reader may transmit the second transmission in accordance with the total reader processing time limit, which may be increased based at least in part on the one or more parameters, the reduce buffering delay, the one or more frame synchronization samples, the one or more header bits, the one or more data bits, and/or the one or more upsampled waveforms.

In some aspects, the reader may maintain a first buffer for a CW transmission and a second buffer for a data transmission. The reader may switch between the first buffer and the second buffer based at least in part on whether the CW transmission or the data transmission is to be transmitted to the tag. In one example, more than one buffer may be used for the data transmission. For example, two or three buffers may be used for the data transmission.

In some aspects, the reader may utilize multiple uplink buffers for uplink transmissions (e.g., a first buffer for CW and a second buffer for data), and the reader may utilize controls to switch between the multiple uplink buffers. In one example, the first buffer may be dedicated for CW transmission, and the second buffer may be dedicated for data transmission. The reader may be configured to switch between different buffers for CW-to-data transmission and data-to-CW transmission. The reader may support the multiple uplink buffers in order to simplify a transmit processing since the reader may pre-generate a CW in one buffer and only generate data samples as applicable using the other buffer.

In some aspects, a T2 timeline may be specific to the tag. For example, different tags may be able to support different T2 timelines. Depending on a tag supported functionality, the reader may select different parameters (e.g., T2, BLF, Tari, and/or data multiple) in a manner that increases the overall reader processing time limit.

As indicated above, FIG. 5 is provided as an example. Other examples may differ from what is described with regard to FIG. 5.

FIG. 6 is a diagram illustrating an example process 600 performed, for example, at a UE or an apparatus of a UE, in accordance with the present disclosure. Example process 600 is an example where the apparatus or the UE (e.g., UE 120) performs operations associated with increasing total reader processing time limits for transmissions.

As shown in FIG. 6, in some aspects, process 600 may include receiving, via a reader associated with the UE and from a tag, a first transmission (block 610). For example, the UE (e.g., using reception component 702 and/or communication manager 706, depicted in FIG. 7) may receive, via a reader associated with the UE and from a tag, a first transmission, as described above.

As further shown in FIG. 6, in some aspects, process 600 may include transmitting, via the reader and to the tag, a second transmission based at least in part on the first transmission, wherein the first transmission and the second transmission are separated by a turnaround time, and wherein one or more parameters, including the turnaround time, are selected to increase a total reader processing time limit associated with one or more of the first transmission or the second transmission (block 620). For example, the UE (e.g., using transmission component 704 and/or communication manager 706, depicted in FIG. 7) may transmit, via the reader and to the tag, a second transmission based at least in part on the first transmission, wherein the first transmission and the second transmission are separated by a turnaround time, and wherein one or more parameters, including the turnaround time, are selected to increase a total reader processing time limit associated with one or more of the first transmission or the second transmission, as described above.

Process 600 may include additional aspects, such as any single aspect or any combination of aspects described below and/or in connection with one or more other processes described elsewhere herein.

In a first aspect, process 600 includes selecting the turnaround time, of the one or more parameters, from a range of available turnaround times, selecting a data encoding type, of the one or more parameters, from a plurality of available data encoding types, selecting a modulation type, of the one or more parameters, from a plurality of available modulation types, and selecting a BLF, of the one or more parameters, from a range of available BLFs, wherein the total reader processing time limit for the second transmission is based at least in part on one or more of the turnaround time, the data encoding type, the modulation type, or the BLF.

In a second aspect, alone or in combination with the first aspect, process 600 includes obtaining a reduced buffering delay based at least in part on one or more of a shortened packet size, one or more blocks of received samples, an increased buffering rate, or a reduced buffer size, and the total reader processing time limit for the second transmission is increased based at least in part on the reduced buffering delay.

In a third aspect, alone or in combination with one or more of the first and second aspects, process 600 includes generating one or more frame synchronization samples or a preamble for the second transmission prior to a receipt of the first transmission, wherein the second transmission is transmitted to the tag based at least in part on the one or more frame synchronization samples or the preamble, and the total reader processing time limit is increased based at least in part on a transmitted duration of the one or more frame synchronization samples or the preamble.

In a fourth aspect, alone or in combination with one or more of the first through third aspects, process 600 includes selecting a Tari, of the one or more parameters, from a range of available Taris, selecting a data multiple, of the one or more parameters, from a group of possible data multiples, and identifying a frame synchronization duration based at least in part on the Tari and the data multiple, wherein the total reader processing time limit for the second transmission is increased based at least in part on the frame synchronization duration and the turnaround time.

In a fifth aspect, alone or in combination with one or more of the first through fourth aspects, process 600 includes generating one or more header bits and one or more data bits for the second transmission prior to a receipt of the first transmission, wherein the second transmission is transmitted to the tag based at least in part on the one or more header bits and the one or more data bits, and the total reader processing time limit is increased based at least in part on the one or more header bits and the one or more data bits.

In a sixth aspect, alone or in combination with one or more of the first through fifth aspects, process 600 includes receiving, via the reader and from the tag, the first transmission includes receiving a portion of bits associated with the first transmission, and transmitting, via the reader and to the tag, the second transmission includes transmitting the portion of bits prior to a receipt of remaining bits associated with the first transmission, wherein the second transmission is an ACK, wherein transmitted bits for the second transmission are derived from bits received from the first transmission, and wherein the remaining bits are subsequently received from the tag and transmitted to the tag.

In a seventh aspect, alone or in combination with one or more of the first through sixth aspects, process 600 includes generating one or more upsampled waveforms for the second transmission prior to a receipt of the first transmission, wherein the one or more upsampled waveforms are based at least in part on component waveforms associated with decomposed past second transmissions, wherein the second transmission is transmitted to the tag based at least in part on the one or more upsampled waveforms, and the total reader processing time limit is increased based at least in part on the one or more upsampled waveforms.

In an eighth aspect, alone or in combination with one or more of the first through seventh aspects, process 600 includes maintaining a first buffer for a CW transmission and a second buffer for a data transmission, and switching between the first buffer and the second buffer based at least in part on whether the CW transmission or the data transmission is to be transmitted to the tag.

In a ninth aspect, alone or in combination with one or more of the first through eighth aspects, the reader is an RFID reader, and the tag is an RFID tag.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication, in accordance with the present disclosure. The apparatus 700 may be a UE, or a UE may include the apparatus 700. In some aspects, the apparatus 700 includes a reception component 702, a transmission component 704, and/or a communication manager 706, which may be in communication with one another (for example, via one or more buses and/or one or more other components). In some aspects, the communication manager 706 is the communication manager 150 described in connection with FIG. 1. As shown, the apparatus 700 may communicate with another apparatus 708, such as a UE or a network node (such as a CU, a DU, an RU, or a base station), using the reception component 702 and the transmission component 704. The communication manager 706 may be included in, or implemented via, a processing system (for example, the processing system 140 described in connection with FIG. 1) of the UE.

In some aspects, the apparatus 700 may be configured to perform one or more operations described herein in connection with FIG. 5. Additionally, or alternatively, the apparatus 700 may be configured to perform one or more processes described herein, such as process 600 of FIG. 6, or a combination thereof. In some aspects, the apparatus 700 and/or one or more components shown in FIG. 7 may include one or more components of the UE described in connection with FIG. 1. Additionally, or alternatively, one or more components shown in FIG. 7 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications, and may provide the processed signals to the one or more other components of the apparatus 700. In some aspects, the reception component 702 may include one or more components of the UE described above in connection with FIG. 1, such as a radio, one or more RF chains, one or more transceivers, or one or more modems, each of which may in turn be coupled with one or more antennas of the UE.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications, and may transmit the processed signals to the apparatus 708. In some aspects, the transmission component 704 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 704 may be co-located with the reception component 702.

The communication manager 706 may support operations of the reception component 702 and/or the transmission component 704. For example, the communication manager 706 may receive information associated with configuring reception of communications by the reception component 702 and/or transmission of communications by the transmission component 704. Additionally, or alternatively, the communication manager 706 may generate and/or provide control information to the reception component 702 and/or the transmission component 704 to control reception and/or transmission of communications.

The reception component 702 may receive, via a reader associated with the UE and from a tag, a first transmission. The transmission component 704 may transmit, via the reader and to the tag, a second transmission based at least in part on the first transmission, wherein the first transmission and the second transmission are separated by a turnaround time, and wherein one or more parameters, including the turnaround time, are selected to increase a total reader processing time limit associated with one or more of the first transmission or the second transmission.

The communication manager 706 may select the turnaround time, of the one or more parameters, from a range of available turnaround times. The communication manager 706 may select a data encoding type, of the one or more parameters, from a plurality of available data encoding types. The communication manager 706 may select a modulation type, of the one or more parameters, from a plurality of available modulation types. The communication manager 706 may select a BLF, of the one or more parameters, from a range of available BLFs, wherein the total reader processing time limit for the second transmission is based at least in part on one or more of the turnaround time, the data encoding type, the modulation type, or the BLF. The communication manager 706 may obtain a reduced buffering delay based at least in part on one or more of: a shortened packet size, one or more blocks of received samples, an increased buffering rate, or a reduced buffer size, and the total reader processing time limit for the second transmission is increased based at least in part on the reduced buffering delay.

The communication manager 706 may generate one or more frame synchronization samples or a preamble for the second transmission prior to a receipt of the first transmission, wherein the second transmission is transmitted to the tag based at least in part on the one or more frame synchronization samples or the preamble, and the total reader processing time limit is increased based at least in part on a transmitted duration of the one or more frame synchronization samples or the preamble. The communication manager 706 may select a Tari, of the one or more parameters, from a range of available Taris. The communication manager 706 may select a data multiple, of the one or more parameters, from a group of possible data multiples. The communication manager 706 may identify a frame synchronization duration based at least in part on the Tari and the data multiple, wherein the total reader processing time limit for the second transmission is increased based at least in part on the frame synchronization duration and the turnaround time.

The communication manager 706 may generate one or more header bits and one or more data bits for the second transmission prior to a receipt of the first transmission, wherein the second transmission is transmitted to the tag based at least in part on the one or more header bits and the one or more data bits, and the total reader processing time limit is increased based at least in part on the one or more header bits and the one or more data bits. The reception component 702 may receive, via the reader and from the tag, the first transmission includes receiving a portion of bits associated with the first transmission. The transmission component 704 may transmit, via the reader and to the tag, the second transmission includes transmitting the portion of bits prior to a receipt of remaining bits associated with the first transmission, wherein the second transmission is an ACK, wherein transmitted bits for the second transmission are derived from bits received from the first transmission, and wherein the remaining bits are subsequently received from the tag and transmitted to the tag.

The communication manager 706 may generate one or more upsampled waveforms for the second transmission prior to a receipt of the first transmission, wherein the one or more upsampled waveforms are based at least in part on component waveforms associated with decomposed past second transmissions, wherein the second transmission is transmitted to the tag based at least in part on the one or more upsampled waveforms, and the total reader processing time limit is increased based at least in part on the one or more upsampled waveforms. The communication manager 706 may maintain a first buffer for a CW transmission and a second buffer for a data transmission. The communication manager 706 may switch between the first buffer and the second buffer based at least in part on whether the CW transmission or the data transmission is to be transmitted to the tag.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

The following provides an overview of some Aspects of the present disclosure:

Aspect 1: A method of wireless communication performed by a user equipment (UE), comprising: receiving, via a reader associated with the UE and from a tag, a first transmission; and transmitting, via the reader and to the tag, a second transmission based at least in part on the first transmission, wherein the first transmission and the second transmission are separated by a turnaround time, and wherein one or more parameters, including the turnaround time, are selected to increase a total reader processing time limit associated with one or more of the first transmission or the second transmission.

Aspect 2: The method of Aspect 1, further comprising: selecting the turnaround time, of the one or more parameters, from a range of available turnaround times; selecting a data encoding type, of the one or more parameters, from a plurality of available data encoding types; selecting a modulation type, of the one or more parameters, from a plurality of available modulation types; and selecting a backscatter link frequency (BLF), of the one or more parameters, from a range of available BLFs, wherein the total reader processing time limit for the second transmission is based at least in part on one or more of the turnaround time, the data encoding type, the modulation type, or the BLF.

Aspect 3: The method of any of Aspects 1-2, further comprising: obtaining a reduced buffering delay based at least in part on one or more of: a shortened packet size, one or more blocks of received samples, an increased buffering rate, or a reduced buffer size, and wherein the total reader processing time limit for the second transmission is increased based at least in part on the reduced buffering delay.

Aspect 4: The method of any of Aspects 1-3, further comprising: generating one or more frame synchronization samples or a preamble for the second transmission prior to a receipt of the first transmission, wherein the second transmission is transmitted to the tag based at least in part on the one or more frame synchronization samples or the preamble, and wherein the total reader processing time limit is increased based at least in part on a transmitted duration of the one or more frame synchronization samples or the preamble.

Aspect 5: The method of any of Aspects 1-4, further comprising: selecting a type A reference interval (Tari), of the one or more parameters, from a range of available Taris; selecting a data multiple, of the one or more parameters, from a group of possible data multiples; and identifying a frame synchronization duration based at least in part on the Tari and the data multiple, wherein the total reader processing time limit for the second transmission is increased based at least in part on the frame synchronization duration and the turnaround time.

Aspect 6: The method of any of Aspects 1-5, further comprising: generating one or more header bits and one or more data bits for the second transmission prior to a receipt of the first transmission, wherein the second transmission is transmitted to the tag based at least in part on the one or more header bits and the one or more data bits, and wherein the total reader processing time limit is increased based at least in part on the one or more header bits and the one or more data bits.

Aspect 7: The method of any of Aspects 1-6, wherein: receiving, via the reader and from the tag, the first transmission includes receiving a portion of bits associated with the first transmission; and transmitting, via the reader and to the tag, the second transmission includes transmitting the portion of bits prior to a receipt of remaining bits associated with the first transmission, wherein the second transmission is an acknowledgement, wherein transmitted bits for the second transmission are derived from bits received from the first transmission, and wherein the remaining bits are subsequently received from the tag and transmitted to the tag.

Aspect 8: The method of any of Aspects 1-7, further comprising: generating one or more upsampled waveforms for the second transmission prior to a receipt of the first transmission, wherein the one or more upsampled waveforms are based at least in part on component waveforms associated with decomposed past second transmissions, wherein the second transmission is transmitted to the tag based at least in part on the one or more upsampled waveforms, and wherein the total reader processing time limit is increased based at least in part on the one or more upsampled waveforms.

Aspect 9: The method of any of Aspects 1-8, further comprising: maintaining a first buffer for a continuous wave transmission and a second buffer for a data transmission; and switching between the first buffer and the second buffer based at least in part on whether the continuous wave transmission or the data transmission is to be transmitted to the tag.

Aspect 10: The method of any of Aspects 1-9, wherein the reader is a radio frequency identification (RFID) reader, and wherein the tag is an RFID tag.

Aspect 11: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-10.

Aspect 12: An apparatus for wireless communication at a device, the apparatus comprising one or more memories and one or more processors coupled to the one or more memories, the one or more processors configured to cause the device to perform the method of one or more of Aspects 1-10.

Aspect 13: An apparatus for wireless communication, the apparatus comprising at least one means for performing the method of one or more of Aspects 1-10.

Aspect 14: A non-transitory computer-readable medium storing code for wireless communication, the code comprising instructions executable by one or more processors to perform the method of one or more of Aspects 1-10.

Aspect 15: A non-transitory computer-readable medium storing a set of instructions for wireless communication, the set of instructions comprising one or more instructions that, when executed by one or more processors of a device, cause the device to perform the method of one or more of Aspects 1-10.

Aspect 16: A device for wireless communication, the device comprising a processing system that includes one or more processors and one or more memories coupled with the one or more processors, the processing system configured to cause the device to perform the method of one or more of Aspects 1-10.

Aspect 17: An apparatus for wireless communication at a device, the apparatus comprising one or more memories and one or more processors coupled to the one or more memories, the one or more processors individually or collectively configured to cause the device to perform the method of one or more of Aspects 1-10.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, configured to cause the UE to:
receive, via a reader associated with the UE and from a tag, a first transmission; and
transmit, via the reader and to the tag, a second transmission based at least in part on the first transmission, wherein the first transmission and the second transmission are separated by a turnaround time, and wherein one or more parameters, including the turnaround time, are selected to increase a total reader processing time limit associated with one or more of the first transmission or the second transmission.

2. The apparatus of claim 1, wherein the one or more processors are further configured to cause the UE to:
select the turnaround time, of the one or more parameters, from a range of available turnaround times;
select a data encoding type, of the one or more parameters, from a plurality of available data encoding types;
select a modulation type, of the one or more parameters, from a plurality of available modulation types; and
select a backscatter link frequency (BLF), of the one or more parameters, from a range of available BLFs, wherein the total reader processing time limit for the second transmission is based at least in part on one or more of the turnaround time, the data encoding type, the modulation type, or the BLF.

3. The apparatus of claim 1, wherein the one or more processors are further configured to cause the UE to:
obtain a reduced buffering delay based at least in part on one or more of: a shortened packet size, one or more blocks of received samples, an increased buffering rate, or a reduced buffer size, and wherein the total reader processing time limit for the second transmission is increased based at least in part on the reduced buffering delay.

4. The apparatus of claim 1, wherein the one or more processors are further configured to cause the UE to:
generate one or more frame synchronization samples or a preamble for the second transmission prior to a receipt of the first transmission, wherein the second transmission is transmitted to the tag based at least in part on the one or more frame synchronization samples or the preamble, and wherein the total reader processing time limit is increased based at least in part on a transmitted duration of the one or more frame synchronization samples or the preamble.

5. The apparatus of claim 1, wherein the one or more processors are further configured to cause the UE to:
select a type A reference interval (Tari), of the one or more parameters, from a range of available Taris;
select a data multiple, of the one or more parameters, from a group of possible data multiples; and
identify a frame synchronization duration based at least in part on the Tari and the data multiple, wherein the total reader processing time limit for the second transmission is increased based at least in part on the frame synchronization duration and the turnaround time.

6. The apparatus of claim 1, wherein the one or more processors are further configured to cause the UE to:
generate one or more header bits and one or more data bits for the second transmission prior to a receipt of the first transmission, wherein the second transmission is transmitted to the tag based at least in part on the one or more header bits and the one or more data bits, and wherein the total reader processing time limit is increased based at least in part on the one or more header bits and the one or more data bits.

7. The apparatus of claim 1, wherein:
the one or more processors, to receive, via the reader and from the tag, the first transmission, are configured to receive a portion of bits associated with the first transmission; and
the one or more processors, to transmit, via the reader and to the tag, the second transmission, are configured to transmit the portion of bits prior to a receipt of remaining bits associated with the first transmission, wherein the second transmission is an acknowledgement, wherein transmitted bits for the second transmission are derived from bits received from the first transmission, and wherein the remaining bits are subsequently received from the tag and transmitted to the tag.

8. The apparatus of claim 1, wherein the one or more processors are further configured to cause the UE to:
generate one or more upsampled waveforms for the second transmission prior to a receipt of the first transmission, wherein the one or more upsampled waveforms are based at least in part on component waveforms associated with decomposed past second transmissions, wherein the second transmission is transmitted to the tag based at least in part on the one or more upsampled waveforms, and wherein the total reader processing time limit is increased based at least in part on the one or more upsampled waveforms.

9. The apparatus of claim 1, wherein the one or more processors are further configured to cause the UE to:
maintain a first buffer for a continuous wave transmission and a second buffer for a data transmission; and
switch between the first buffer and the second buffer based at least in part on whether the continuous wave transmission or the data transmission is to be transmitted to the tag.

10. The apparatus of claim 1, wherein the reader is a radio frequency identification (RFID) reader, and wherein the tag is an RFID tag.

11. A method of wireless communication performed by a user equipment (UE), comprising:
receiving, via a reader associated with the UE and from a tag, a first transmission; and
transmitting, via the reader and to the tag, a second transmission based at least in part on the first transmission, wherein the first transmission and the second transmission are separated by a turnaround time, and wherein one or more parameters, including the turnaround time, are selected to increase a total reader processing time limit associated with one or more of the first transmission or the second transmission.

12. The method of claim 11, further comprising:
selecting the turnaround time, of the one or more parameters, from a range of available turnaround times; and
selecting a data encoding type, of the one or more parameters, from a plurality of available data encoding types;
selecting a modulation type, of the one or more parameters, from a plurality of available modulation types; and
selecting a backscatter link frequency (BLF), of the one or more parameters, from a range of available BLFs, wherein the total reader processing time limit for the second transmission is based at least in part on one or more of the turnaround time, the data encoding type, the modulation type, or the BLF.

13. The method of claim 11, further comprising:
obtaining a reduced buffering delay based at least in part on one or more of: a shortened packet size, one or more blocks of received samples, an increased buffering rate, or a reduced buffer size, and wherein the total reader processing time limit for the second transmission is increased based at least in part on the reduced buffering delay.

14. The method of claim 11, further comprising:
generating one or more frame synchronization samples or a preamble for the second transmission prior to a receipt of the first transmission, wherein the second transmission is transmitted to the tag based at least in part on the one or more frame synchronization samples or the preamble, and wherein the total reader processing time limit is increased based at least in part on a transmitted duration of the one or more frame synchronization samples or the preamble.

15. The method of claim 11, further comprising:
selecting a type A reference interval (Tari), of the one or more parameters, from a range of available Taris;
selecting a data multiple, of the one or more parameters, from a group of possible data multiples; and
identifying a frame synchronization duration based at least in part on the Tari and the data multiple, wherein the total reader processing time limit for the second transmission is increased based at least in part on the frame synchronization duration and the turnaround time.

16. The method of claim 11, further comprising:
generating one or more header bits and one or more data bits for the second transmission prior to a receipt of the first transmission, wherein the second transmission is transmitted to the tag based at least in part on the one or more header bits and the one or more data bits, and wherein the total reader processing time limit is increased based at least in part on the one or more header bits and the one or more data bits.

17. The method of claim 11, wherein:
receiving, via the reader and from the tag, the first transmission includes receiving a portion of bits associated with the first transmission; and
transmitting, via the reader and to the tag, the second transmission includes transmitting the portion of bits prior to a receipt of remaining bits associated with the first transmission, wherein the second transmission is an acknowledgement, wherein transmitted bits for the second transmission are derived from bits received from the first transmission, and wherein the remaining bits are subsequently received from the tag and transmitted to the tag.

18. The method of claim 11, further comprising:
generating one or more upsampled waveforms for the second transmission prior to a receipt of the first transmission, wherein the one or more upsampled waveforms are based at least in part on component waveforms associated with decomposed past second transmissions, wherein the second transmission is transmitted to the tag based at least in part on the one or more upsampled waveforms, and wherein the total reader processing time limit is increased based at least in part on the one or more upsampled waveforms.

19. The method of claim 11, further comprising:
maintaining a first buffer for a continuous wave transmission and a second buffer for a data transmission; and
switching between the first buffer and the second buffer based at least in part on whether the continuous wave transmission or the data transmission is to be transmitted to the tag.

20. A non-transitory computer-readable medium storing a set of instructions for wireless communication, the set of instructions comprising:
one or more instructions that, when executed by one or more processors of a user equipment (UE), cause the UE to:
receive, via a reader associated with the UE and from a tag, a first transmission; and
transmit, via the reader and to the tag, a second transmission based at least in part on the first transmission, wherein the first transmission and the second transmission are separated by a turnaround time, and wherein one or more parameters, including the turnaround time, are selected to increase a total reader processing time limit associated with one or more of the first transmission or the second transmission.
